(19) United States
(12) Patent Application Publication
(10) Pub. No.: US 2024/0391182 A1
(43) Pub. Date: Nov. 28, 2024

(54) MATERIAL WELDER AND METHOD OF WELDING

(71) Applicant: Garth JACOBS, Carrum Downs, Victoria (AU)

(72) Inventor: Garth JACOBS, Carrum Downs, Victoria (AU)

(21) Appl. No.: 18/576,390

(22) PCT Filed: Aug. 25, 2021
(86) PCT No.: PCT/AU2021/050959

§ 371 Date: Jan. 4, 2024

(30) Foreign Application Priority Data
Jul. 5, 2021 (AU) 2021902042

(51) Int. Cl. B29C 65/00

(52) U.S. Cl. CPC B29C 66/0044; B29C 66/81811; B29C 66/81871

(57) ABSTRACT

A material welder for welding portions of a material together, including: elongate top and bottom bar assemblies extending in a longitudinal direction and configured in overlying arrangement to define a welding zone between them, each of the bar assemblies including a first and second heating element substantially in the same plane, the first and second heating elements being substantially adjacent one another such that when all the heating elements are heated, the welding process results in a weld that is substantially continuous in a transverse direction; and an actuator adapted to move the top bar assembly towards the bottom bar assembly and/or the bottom assembly towards the top assembly such that the first and second heating elements of the top bar assembly align with the first and second heating elements of the bottom bar assembly.

### FIELD OF THE INVENTION

The present invention relates to a material welder and method of welding. More particularly, this invention relates to a material welder for welding material made of weldable materials including plastic.

### BACKGROUND

Material welders including weld beams or bars that are heated then pressed onto the material to join the material together are known. Such an arrangement is disclosed in PCT/AU2020/050558 (WO2020/243773) to the present applicant, the entire contents of which are incorporated by reference herein.

With machines of this type, numerous difficulties need to be overcome to provide a straight, uniform weld without deformation (rippling, puckering etc) of the material.

Furthermore, machines of this type are often required to weld a zipper track or other feature (such as a Keder® spline, welting/piping) to an end of a portion of the material, which can be difficult without deformation (rippling, puckering etc) of the material/weld.

There is a need to address the above, and/or at least provide a useful alternative.

### SUMMARY

According to a first aspect of the present invention, there is provided a material welder for welding portions of a material together, including:
elongate top and bottom bar assemblies extending in a longitudinal direction and configured in overlying arrangement to define a welding zone between them, each of the top and bottom bar assemblies including a first and second heating element substantially in the same plane, the first and second heating elements being substantially adjacent one another such that when all the heating elements are heated, the welding process results in a weld that is substantially continuous in a transverse direction; and
an actuator device adapted to move the top bar assembly towards the bottom bar assembly and/or the bottom bar assembly towards the top bar assembly such that the first heating element of the top bar assembly aligns with the first heating element of the bottom bar assembly and the second heating element of the top bar assembly aligns with the second heating element of the bottom bar assembly;
wherein the top and bottom bar assemblies each include:
   a mounting underlying each of the first and second heating elements, the mounting of each of the first and second heating elements being generally adjacent each other;
   a first layer of non-stick material disposed between a respective heating element and the mounting on which it is mounted, the first layer extending to a location between the adjacent mountings;
   a second layer of non-stick material extending over a respective heating element and to a location between the adjacent mounting elements; and
   a third layer of non-stick material forming a cover which extends over the second layers of the heating elements and over sides of the mountings, the third layer forming a contact surface for contacting the material during the welding process.

According to a preferred embodiment of the present invention, the welder further includes generally planar members positioned closely adjacent to either side of the bottom bar assembly, each planar member being height adjustable so that, in use, an edge of each generally planar member which is proximal to the bottom bar assembly can be used to position respective portions of material; and a clamp under one of the generally planar members, the clamp releasably engaging an end of a first portion of material to be welded to a second portion of material.

According to another aspect of the present invention, there is provided a material welder for welding portions of a material together, including:
a top bar assembly and a bottom bar assembly, each assembly extending in a longitudinal direction, a portion of the top bar assembly being directly above a portion of the bottom bar assembly, the top bar assembly including a first and second heating element substantially in the same plane and the bottom bar assembly including a first and second heating element substantially in the same plane;
an actuator device adapted to move the top bar assembly towards the bottom bar assembly and/or the bottom bar assembly towards the top bar assembly such that the first heating element of the top bar assembly aligns with the first heating element of the bottom bar assembly and the second heating element of the top bar assembly aligns with the second heating element of the bottom bar assembly;
contact surfaces associated with respective heating elements of each of the bar assemblies adapted to contact the material during a welding process, the contact surfaces comprising top contact surfaces of the top bar assembly and bottom contact surfaces of the bottom bar assembly, the top contact surfaces being substantially adjacent one another and the bottom contact surfaces being substantially adjacent one another such that when the top and bottom contact surfaces contact the material and all the heating elements are heated, the resulting weld is substantially continuous in a transverse direction;
generally planar members positioned closely adjacent to either side of the bottom bar assembly, each planar member being height adjustable so that, in use, an edge of each generally planar member which is proximal to the bottom bar assembly can be used to position respective portions of material; and
a clamp under one of the generally planar members, the clamp releasably engaging an end of a first portion of material to be welded to a second portion of material.

Preferably, a height of the clamp is variable to allow the height of the first portion of material to be raised and sit generally parallel with the second portion of material.

The clamp can include upper and lower members forming jaws, the upper member being secured to the generally planar member and the lower member pivotable relative to the upper member to open and close the jaw.

The clamp can be configured to accept a portion of material having a generally circular profile, formed by an internal core around which the material is wrapped.

Preferably, the heating elements can be selectively activated to heat either the first heating elements or all the first and second heating elements.

At least one of the top and bottom bar assemblies can further include at least one hole and/or channel adapted such that fluid or air is circulated through the holes and/or channels and through a cooling device to cool the heating elements.

Preferably, at least one tensioning mechanism is attached to each end of each of the heating elements and is adapted to pull the heating elements into a state of tension.

Preferably, the actuator device is adapted to move the top bar assembly towards the bottom bar assembly. In some embodiments, the first and second heating elements are between about 5 to 20 mm wide, preferably between about 8 to 16 mm wide, most preferably about 10 mm wide.

Preferably, the contact surfaces of the top bar assembly and/or the contacts surface of the bottom bar assembly are substantially flat. Preferably, the contact surfaces of the top bar assembly and/or the contact surfaces of the bottom bar assembly are coated with a non-stick material, preferably polytetrafluoroethylene (Teflon), fluorinated ethylene propylene, or similar non-stick materials.

According to another aspect of the invention, there is provided a method of welding two portions of material together, including the steps of:
providing a material welder of the above described type;
overlapping first and second portions of material such that a location of a desired weld is between the top bar assembly and bottom bar assembly;
activating the first heating element of the first top bar assembly and first heating element of the bottom bar assembly, or the second heating element of the top bar assembly and the second heating element of the bottom bar assembly or the first and second heating elements of the top bar assembly and the first and second heating element of the bottom bar assembly
activating the actuator device to raise the bottom bar assembly and/or lower the top bar assembly until the contact surfaces contact and/or apply force to the material, then raising the top bar assembly and/or lowering the bottom bar assembly.

According to another aspect of the invention, there is provided a method of welding two portions of material together, including the steps of:
providing a material welder of the above described type;
raising the clamp and its associated planar member;
opening the clamp and inserting therein an end a portion of material;
activating the first heating element of the first top bar assembly and first heating element of the bottom bar assembly, or the second heating element of the top bar assembly and the second heating element of the bottom bar assembly or the first and second heating elements of the top bar assembly and the first and second heating element of the bottom bar assembly
activating the actuator device to raise the bottom bar assembly and/or lower the top bar assembly until the contact surfaces contact and/or apply force to the material, then raising the top bar assembly and/or lowering the bottom bar assembly.

Preferably, one of the portions of material has, at the end to be received in the clamp, a generally circular profile formed by an internal core around which the material is wrapped.

Preferably, one of the portions of material has, at the end to be received in the clamp, a zipper track or spline.

### BRIEF DESCRIPTION OF THE DRAWINGS

In order that the invention may be more easily understood, an embodiment will now be described, by way of example only, with reference to the accompanying drawings in which:

FIG. 1 is a perspective view of a material welder according to one embodiment of the invention;

FIG. 2 is a front view of the material welder of FIG. 1;

FIG. 3 is a close side view of the material welder of FIG. 1, showing a contact surface of a lower weld bar;

FIG. 4 is a cross sectional view of a lower weld bar;

FIG. 5 is an end view of the welder;

FIG. 6 is a perspective view of a portion of material with piping along one end thereof;

FIG. 7 is an end view of the welder with the piping received in a clamp, the clamp being in an open condition;

FIG. 8 is an end view of the welder with the piping received in a clamp, the clamp being in a closed condition ready for welding;

FIG. 9 is a sectional view of the welder; and

FIG. 10 is another sectional view of the welder.

### DETAILED DESCRIPTION

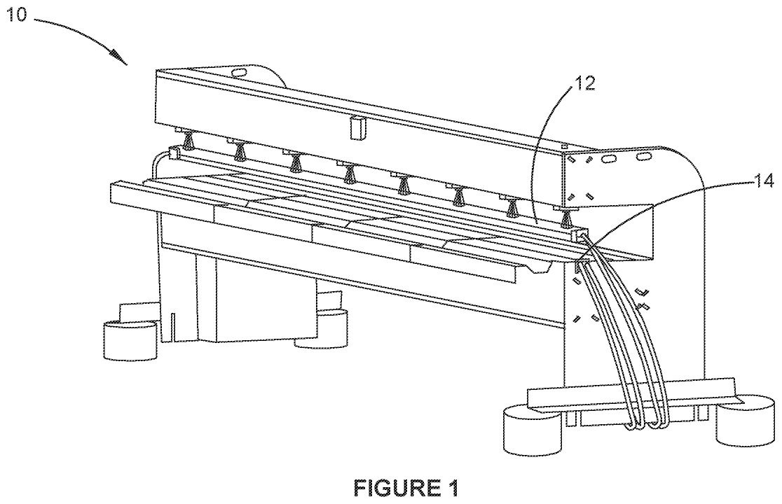

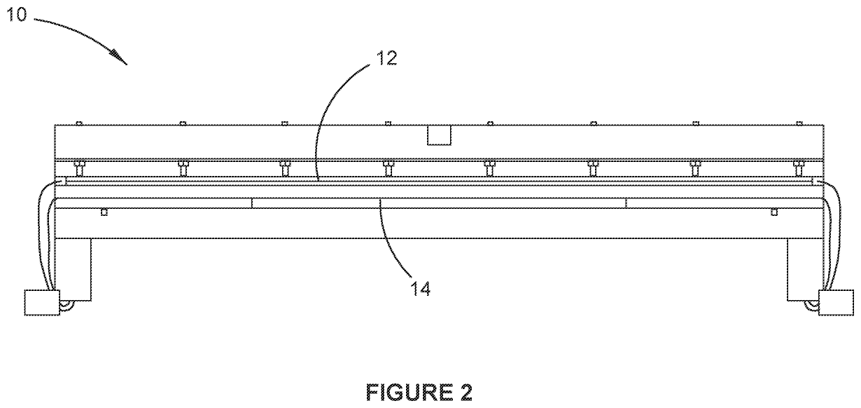

A material welder 10 according to a preferred embodiment of the invention is illustrated in FIG. 1. The welder 10 is configured for welding portions of a material together.

The welder 10 includes an elongate top bar assembly 12 and an elongate bottom bar assembly 14. Each of the bar assemblies 12, 14 extend in a longitudinal direction and are configured in overlying arrangement to define a welding zone between them. In this regard, the top bar assembly 12 and the bottom bar assembly 14 are substantially aligned when brought together to define the weld zone.

The top and bottom bar assemblies 12, 14 both include first and second heating elements 16, 18 substantially in the same plane. The first and second heating elements 16, 18 are substantially adjacent one another such that when all the heating elements are heated, the welding process results in a weld that is substantially continuous in a transverse direction.

The welder 10 is configured so as to selectively heat either the first heating elements, the second heating elements, or both the first and second heating elements. This allows a selectable control of the weld width of the material. To illustrate, if all heating elements are each 10 mm wide, when the first top and bottom heating elements are heated, the weld width will be 10 mm and when all heating elements are heated, the weld width will be 20 mm. Thus the weld with may be adjusted based on the heating element width and selectively controlling the heating and/or cooling of those elements.

The first and second heating elements 16, 18 are between about 5 to 20 mm wide, preferably between about 8 to 16 mm wide, most preferably about 10 mm wide.

At least one tensioning mechanism may be provided and attached to each end of each of the heating elements 16, 18 and is adapted to pull the heating elements into a state of tension.

The welder 10 further includes an actuator device adapted to move the top bar assembly 12 towards the bottom bar assembly 14 to allow for welding of the material between the top bar assembly 12 and the bottom bar assembly 14. Alternatively, the bottom bar assembly 14 may move towards the top bar assembly 12, or both the top and bottom bar assemblies 12, 14 may move toward each other.

A cross section of bottom bar assembly 14 is illustrated in FIG. 4. It will be appreciated that the top bar assembly 12 is configured in the same manner though rotated 180 degrees about its longitudinal axis. For succinctness, the top bar assembly 12 will not be separately described herein.

Bottom bar assembly 14 includes first heating element 16 with a mounting 17 underlying it, and a second heating element 18 with a mounting 19 underlying it. The mountings 17, 19 are generally adjacent each other.

A first layer of non-stick material 20 is disposed between the first heating element 16 and mounting 17 and the second heating element 18 and mounting 19. The first layer 20 is disposed between the respective heating element and extends to a location between the adjacent mountings 17, 19.

Mountings 17 and 19 are preferably formed of silicon so as to electrically isolate the heating elements from other components of the welder. Providing a first layer 20 of non-stick material has been found to allow heating elements 16, 18 to expand and contract in a longitudinal direction. As the length of the heating elements 16, 18 are often 6 metres in length, this longitudinal expansion and contraction can be significant and can contribute to buckling of the heating elements and imperfections in the resulting weld.

The first layer 20 extends between the mountings 17, 19 to allow movement therebetween.

A second layer of non-stick material 22 extends over heating elements 16, 18 and between the mountings 17, 19 to electrically isolate the two heating elements 16, 18 from each other. A layer of non-stick material 22 is required above the heating elements 16, 18 to prevent contact between the heating elements 16, 18 and the material to be welded, which would lead to adhesion.

A third layer of non-stick material 24 forms a cover which extends over the second layers 22 of the heating elements 16, 18 and over outer sides of the mountings 17, 19. The third layer 24 forms a contact surface for contacting the material during the welding process. The third layer 24 provides a sacrificial coated which will wear over time and can easily be replaced. Also, as the third layer 24 extends over outer sides of the mountings 17, 19, the third layer 24 acts to hold the bottom bar assembly 14 together.

The third layer 24 is also helpful to evenly distribute heat from the heating elements 16, 18. The heating elements 16, 18 necessarily need to be separated to prevent electrical shorting, though the separation is desired to be minimised to prevent a line appearing between the two welds. As heat flows through the second layer 22 and third layer 24, it disperses more evenly, so as to provide a generally even heat distribution at the contact surface so that the resulting weld appears to be continuous and not formed by two separate weld bars.

The contact surface formed by the third layers 24 are substantially flat. Each of the first, second and third layers, 20, 22, 24 are preferably formed of polytetrafluoroethylene (Teflon), fluorinated ethylene propylene, or similar non-stick materials.

Either the top bar assembly 12 or the bottom bar assembly 14 (or both) can further include at least one hole and/or channel adapted such that fluid or air is circulated through the holes and/or channels and through a cooling device to cool the heating elements 16, 18.

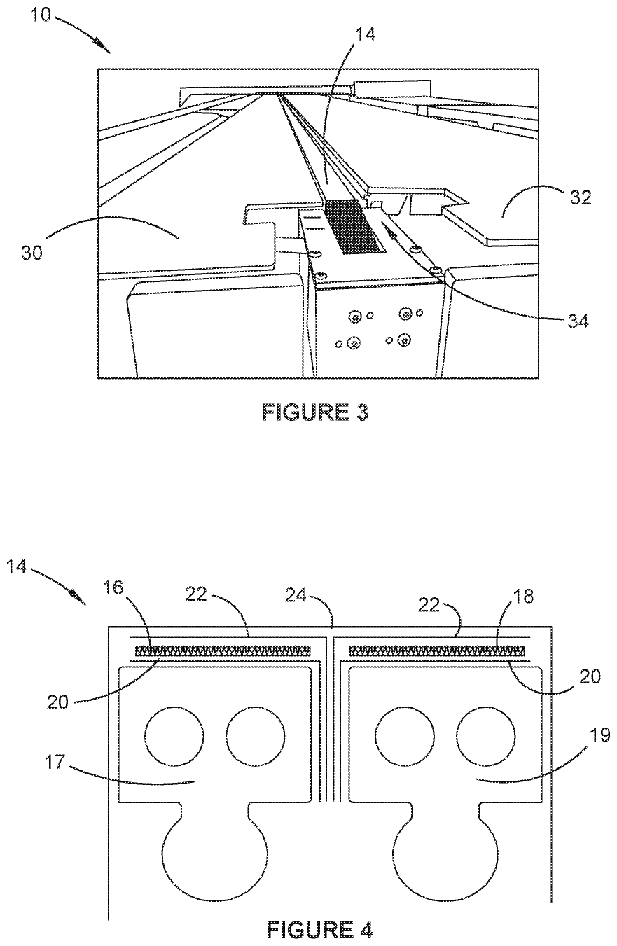

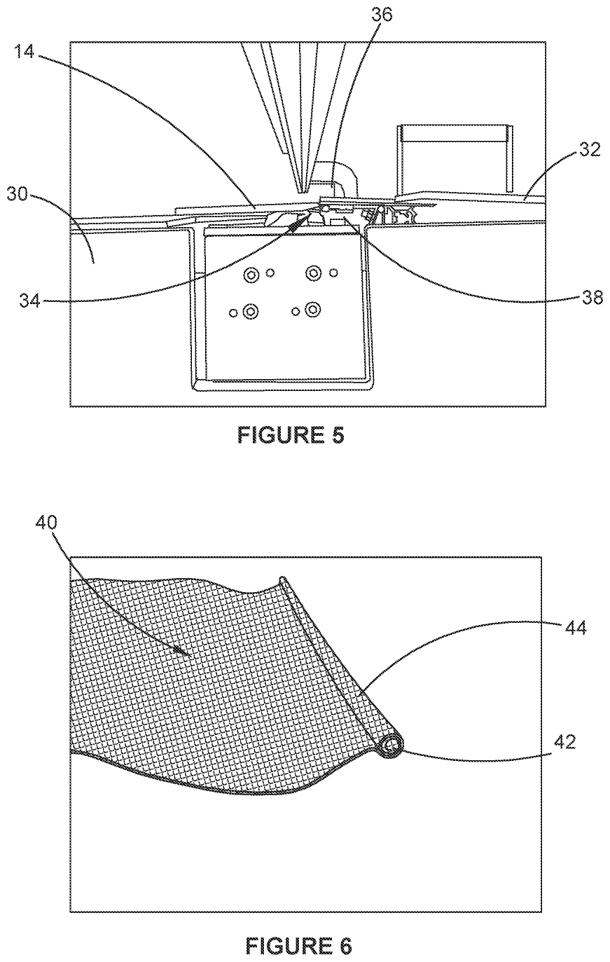

As illustrated in FIG. 3, the welder 10 includes generally planar members 30, 32 positioned closely adjacent to either side of the bottom bar assembly 14. The planar members 30, 32 may be identical or differently configured, and may contain recesses or indentations. Each planar member 30, 32 is height adjustable so that, in use, an edge of the planar member 30, 32 which is proximal to the bottom bar assembly 14 can be used to position respective portions of material. In this regard, the planar member 30 may first be raised so that a first portion of material is placed over the second planar member and in abutting engagement with member 30. After holding the first portion of material in place with magnets, the second planar member 32 may be raised and the second portion of material positioned in abutting engagement with an edge of the second planer member 32.

A clamp 34 may be provided under one of the generally planar members. In the illustrated embodiment, the clamp 34 is provided under planar member 32, though it will be appreciated that the clamp may also be provided under planar member 30. The clamp 34 is configure to releasably engage an end of a first portion of material to be welded to a second portion of material. The clamp 34 is particularly useful for holding a zipper, Keder spline or piping that is to be welded to a portion of material to allow the material to be secured in use.

Clamp 34 includes an upper jaw member 36 and a lower jaw member 38, which together form clamping jaws. The upper member 36 is secured to generally planar member 32 and the lower member 38 is pivotable relative to the upper member 36 to open and close the jaw.

In the illustrated embodiments, the clamp 34 is configured to accept a portion of material 40 having a generally circular profile, such as that illustrated in FIG. 6. The material 40 is wrapped around an internal core 42 to form piping 44, which is received in a circular channel to secure the material 40. The internal core 42 is preferably plastic, though may also be formed of other materials. Such a connection is commonly known as Keder™.

The clamp 34 may also receive other securing devices, such as a zipper track for example.

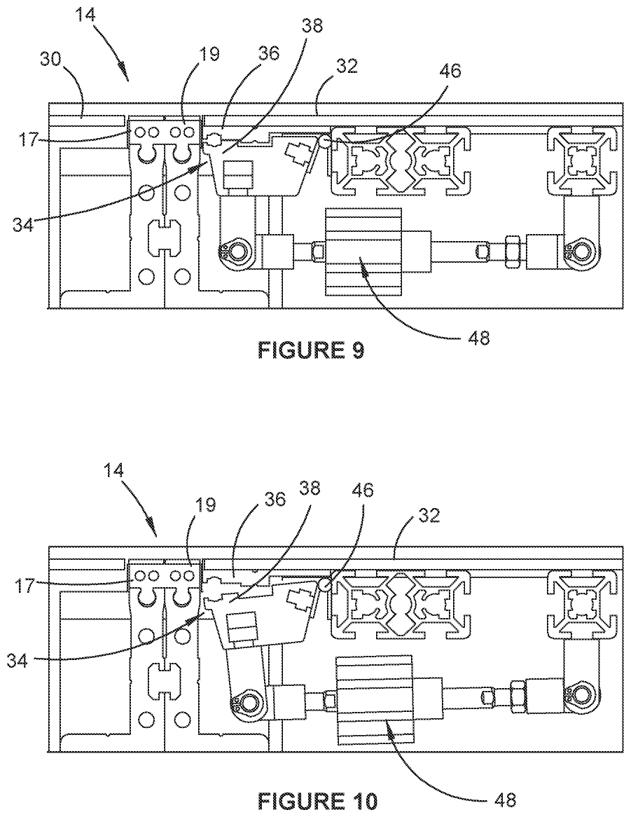

FIGS. 9 and 10 illustrate an example configuration of the clamp 34. Clamp 34 is shown in FIG. 9 in a closed condition and in FIG. 10 in an open condition. Upper member 36 is secured to the planar member 32 and lower member 38 is pivotably mounted via hinge 46. Linear actuator assembly 48 is provided to effect rotation of the lower member 38, though it will be appreciated that other means may be used to effect rotation. The actuator assembly 48 is also secured to a lower side of the planer member 32 so that as the planar member 32 moves up and down, operation of the clamp 34 is not affected.

As the height of the planar member 32 is variable, the height of the clamp can be varied to allow the height of the first portion of material to be raised and sit generally parallel with the second portion of material, thereby providing a straight, uniform weld. Were either portion of material to be inclined relative to the other, a crooked weld could be achieved.

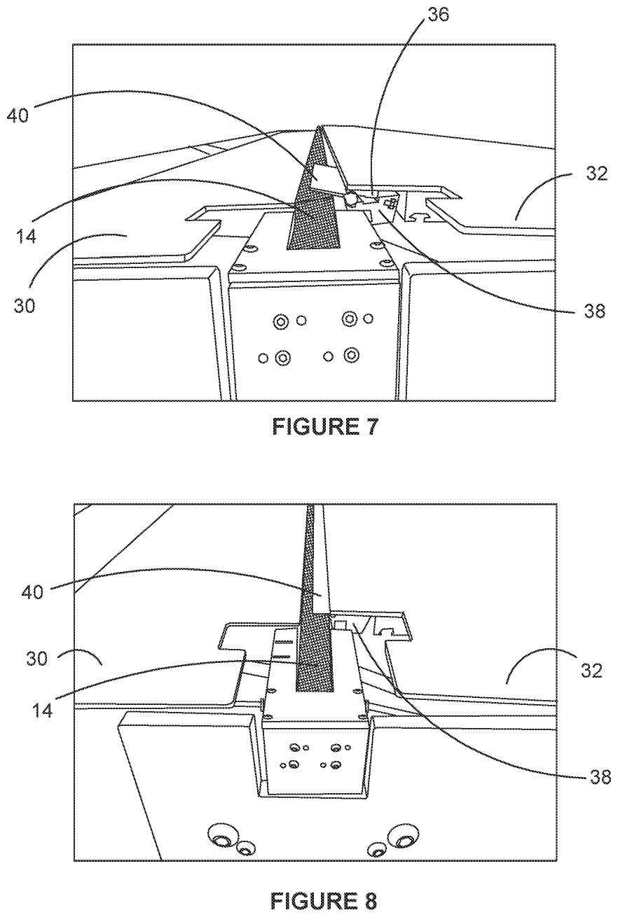

In FIG. 7, jaws 36, 38 are shown apart to enable the material 40 to be received therein. Once inserted, the jaws 36, 38 are closed to secure the material 40. As the jaws 36, 38 are closed, the height of the planar member 32 may be varied to bring the material 40 into alignment with the material to which it is to be welded.

In use, first and second portions of material are located in overlapping arrangement such that a location of a desired weld is between the top bar assembly and bottom bar assembly.

The first heating element 16 of the top bar assembly 12 and the first heating element 16 of the bottom bar assembly 14, or the second heating element 18 of the top bar assembly 12 and the second heating element 18 of the bottom bar assembly 14 or both the first and second heating elements 16, 18 of the top bar assembly 12 and the first and second heating elements 16, 18 of the bottom bar assembly 14 are activated.

The actuator device is then activated to raise the bottom bar assembly 14 and/or lower the top bar assembly 12 until the contact surfaces contact and/or apply force to the material to perform the welding operation, before the top bar assembly 12 and the bottom bar assembly 14 are separated to remove the material.

If one of the portions of material has a securement on an end thereof, in the form of a zipper track or a generally circular profile, the securement is received in a clamp that is accessed by raising its associated planar member. Such an arrangement is illustrated in FIGS. 7 and 8. The clamp 34 is opened and an end a portion of material received therein. The first heating element 16 of the first top bar assembly 12 and first heating element 16 of the bottom bar assembly 14, or the second heating element 16 of the top bar assembly 12 and the second heating element 16 of the bottom bar assembly 14 or both the first and second heating elements 16, 18 of the top bar assembly 12 and the first and second heating elements 16, 18 of the bottom bar assembly 14 are activated and the actuator used to bring the bottom bar assembly 14 into contact with the top bar assembly 12 to perform the welding operation.

The material for welding in the above description is weldable, such that the welding process uses the properties of the materials to be joined to hold them together so that no sewing, adhesive, seam tape or other fasteners are required to join them or can be used in conjunction with other joining methods. The material may be substantially made of the weldable material or coated with a weldable material.

The material may be a fabric or a fabric coated in a plastic. The material may be made of materials including plastic, metal, natural fibres or materials such as cotton and composites such as fibre glass. The main portion of the material may be substantially made of PVC, acrylic or vinyl. The material may substantially be made of PVC, acrylic or vinyl. The material may substantially be made of a fibre such as canvas coated in a plastic such as PVC. The fibres may be arranged in a woven pattern. The material may include multiple layers. The multiple layers may be welded or stitched together. The bead may include a rope positioned in a fold of the material. The material may include zips, eyelet loops or other features.

The material welder may be adapted to weld two or three portions of material together. The at least two portions of the material may include at least two portions of a single piece of material. The single piece of material may be folded such that a first portion of the material overlaps a second portion of the material. The at least two portions of material may include the first and second portion of the material. The at least two portions of the material may include at least two portions of multiple pieces of material. The at least two portions may include for example, at least one portion from a first continuous piece of material and at least one portion from a second continuous piece of material.

Many modifications of the above embodiments will be apparent to those skilled in the art without departing from the scope of the present invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A material welder for welding portions of a material together, including:
elongate top and bottom bar assemblies extending in a longitudinal direction and configured in overlying arrangement to define a welding zone between them, each of the top and bottom bar assemblies including a first and second heating element substantially in the same plane, the first and second heating elements being substantially adjacent one another such that when all the heating elements are heated, the welding process results in a weld that is substantially continuous in a transverse direction; and
an actuator device adapted to move the top bar assembly towards the bottom bar assembly and/or the bottom bar assembly towards the top bar assembly such that the first heating element of the top bar assembly aligns with the first heating element of the bottom bar assembly and the second heating element of the top bar assembly aligns with the second heating element of the bottom bar assembly;
wherein the top and bottom bar assemblies each include:
a mounting underlying each of the first and second heating elements, the mounting of each of the first and second heating elements being generally adjacent each other;
a first layer of non-stick material disposed between a respective heating element and the mounting on which it is mounted, the first layer extending to a location between the adjacent mountings;
a second layer of non-stick material extending over a respective heating element and to a location between the adjacent mounting elements; and
a third layer of non-stick material forming a cover which extends over the second layers of the heating elements and over sides of the mountings, the third layer forming a contact surface for contacting the material during the welding process.

2. A material welder as claimed in claim 1, further including generally planar members positioned closely adjacent to either side of the bottom bar assembly, each planar member being height adjustable so that, in use, an edge of each generally planar member which is proximal to the bottom bar assembly can be used to position respective portions of material; and a clamp under one of the generally planar members, the clamp releasably engaging an end of a first portion of material to be welded to a second portion of material.

3. A material welder for welding portions of a material together, including:
a top bar assembly and a bottom bar assembly, each assembly extending in a longitudinal direction, a portion of the top bar assembly being directly above a portion of the bottom bar assembly, the top bar assembly including a first and second heating element substantially in the same plane and the bottom bar assembly including a first and second heating element substantially in the same plane;
an actuator device adapted to move the top bar assembly towards the bottom bar assembly and/or the bottom bar assembly towards the top bar assembly such that the first heating element of the top bar assembly aligns with the first heating element of the bottom bar assembly and the second heating element of the top bar assembly aligns with the second heating element of the bottom bar assembly;
contact surfaces associated with respective heating elements of each of the bar assemblies adapted to contact the material during a welding process, the contact surfaces comprising top contact surfaces of the top bar assembly and bottom contact surfaces of the bottom bar assembly, the top contact surfaces being substantially adjacent one another and the bottom contact surfaces being substantially adjacent one another such that when the top and bottom contact surfaces contact the material and all the heating elements are heated, the resulting weld is substantially continuous in a transverse direction;
generally planar members positioned closely adjacent to either side of the bottom bar assembly, each planar member being height adjustable so that, in use, an edge of each generally planar member which is proximal to the bottom bar assembly can be used to position respective portions of material; and
a clamp under one of the generally planar members, the clamp releasably engaging an end of a first portion of material to be welded to a second portion of material.

4. A material welder as claimed in claim 2, wherein a height of the clamp is variable to allow the height of the first portion of material to be raised and sit generally parallel with the second portion of material

5. A material welder as claimed in claim 2, wherein the clamp includes upper and lower members forming jaws, the upper member being secured to the generally planar member and the lower member pivotable relative to the upper member to open and close the jaw.

6. A material welder as claimed in claim 2, wherein the clamp is configured to accept a zip or a portion of material having a generally circular profile, formed by an internal core around which the material is wrapped.

7. A material welder as claimed in claim 1, wherein the heating elements can be selectively activated to heat either the first heating elements or all the first and second heating elements.

8. A material welder as claimed in claim 1, wherein at least one of the top and bottom bar assemblies further includes at least one hole and/or channel adapted such that fluid or air is circulated through the holes and/or channels and through a cooling device to cool the heating elements.

9. A material welder as claimed in claim 1, wherein at least one tensioning mechanism is attached to each end of each of the heating elements and is adapted to pull the heating elements into a state of tension.

10. A material welder as claimed in claim 1, wherein the actuator device is adapted to move the top bar assembly towards the bottom bar assembly.

11. A material welder as claimed in claim 1, wherein the first and second heating elements are between about 5 to 20 mm wide, preferably between about 8 to 16 mm wide, most preferably about 10 mm wide.

12. A material welder as claimed in claim 1, wherein the contact surfaces of the top bar assembly and/or the contacts surface of the bottom bar assembly are substantially flat.

13. A material welder as claimed in claim 1, wherein the contact surfaces of the top bar assembly and/or the contact surfaces of the bottom bar assembly are coated with a non-stick material, preferably polytetrafluoroethylene (Teflon), fluorinated ethylene propylene, or similar non-stick materials.

14. A method of welding two portions of material together, including the steps of:
providing a material welder according to claim 1;
overlapping first and second portions of material such that a location of a desired weld is between the top bar assembly and bottom bar assembly;
activating the first heating element of the first top bar assembly and first heating element of the bottom bar assembly, or the second heating element of the top bar assembly and the second heating element of the bottom bar assembly or the first and second heating elements of the top bar assembly and the first and second heating element of the bottom bar assembly
activating the actuator device to raise the bottom bar assembly and/or lower the top bar assembly until the contact surfaces contact and/or apply force to the material, then raising the top bar assembly and/or lowering the bottom bar assembly.

15. A method of welding two portions of material together, including the steps of:
providing a material welder according to claim 3;
raising the clamp and its associated planar member;
opening the clamp and inserting therein an end a portion of material;
activating the first heating element of the first top bar assembly and first heating element of the bottom bar assembly, or the second heating element of the top bar assembly and the second heating element of the bottom bar assembly or the first and second heating elements of the top bar assembly and the first and second heating element of the bottom bar assembly
activating the actuator device to raise the bottom bar assembly and/or lower the top bar assembly until the contact surfaces contact and/or apply force to the material, then raising the top bar assembly and/or lowering the bottom bar assembly.

16. A method as claimed in claim 15, wherein one of the portions of material has, at the end to be received in the clamp, a generally circular profile formed by an internal core around which the material is wrapped.

17. A method as claimed in claim 15, wherein one of the portions of material has, at the end to be received in the clamp, a zipper track.
